(19) United States
(12) Patent Application Publication
(10) Pub. No.: US 2005/0249371 A1
(43) Pub. Date: Nov. 10, 2005

(54) Hearing device designed to be worn behind the ear

(75) Inventor: Ole Vogt, Schmerikon (CH)

Correspondence Address: PEARNE & GORDON LLP, 1801 EAST 9TH STREET, SUITE 1200, CLEVELAND, OH, 44114-3108, US

(73) Assignee: Phonak AG, Stafa (CH)

(21) Appl. No.: 10/838,460

(22) Filed: May 4, 2004

(51) Int. Cl. H04R 25/00

(52) U.S. Cl. 381/330; 381/328

(57) ABSTRACT

At the hearing device, in particular suitable for being worn at the pinna or behind the ear, respectively, comprising an exit (3) for acoustic or sound signals a tube-like connecting element (7) is arranged at the exit (3) for connecting the exit (3) with a tube (9) for the sound or acoustic transmission into or to the ear canal. The connecting element has a bending angle of less than 80° and the tube (9) is preferably inserted into the connecting element (7), the interior diameter of the acoustic canal (9) of the connecting element (7) corresponds approximately to the outer diameter of the tube.

The present invention refers to a hearing device in particularly designed for being worn at the pinna or behind the ear, respectively, according to the wording of claim 1.

At the pinna or behind the ear worn hearing devices usually comprise at the exit for the acoustic signal so-called hearing means or an arcuated acoustic transmission element, respectively, on which an acoustic connection tube is attached for the transmission of the signal or sound, respectively, into the auditory canal. This transmission element, arranged at the hearing device including the tube for the auditory canal, is noticeable, usually does not optimally attach to the anatomic characteristics and furthermore, due to the bending and shoulders within the acoustic transmission canal, impedance jumps or defects, respectively, may occur within the transmission of the sound. Correspondingly, within the WO99/04601 it is proposed to use a preformed connection tube made out of rigid material for the transmission of the acoustic signals. The disadvantage is that practically each tube has to be adapted to the respective anatomy of each ear.

Therefore, it is an object of the present invention to propose a solution for solving the above described problem.

According to the present invention, a hearing device is proposed, particularly suitable for being worn at the pinna or behind the ear, respectively, according to the wording of claim 1.

In opposition to the usually used so-called hearing angle which is directly arranged at the acoustic exit of the hearing device and which usually has a bending angle of approximately 90°, it is proposed, according to the present invention, to arrange a tube-like connecting element at the acoustic exit for connecting the exit with a tube for the transmission of sound or acoustics, respectively, into the ear canal which has a bending angle of less than 80°.

According to designed solution, it is proposed to guide the tube into the connecting element, which means that the inside diameter of the acoustic transmission canal within the connecting element corresponds approximately to the outside diameter of the tube, so that the latter can be introduced into the acoustic transmission canal.

Further, it is proposed to definitely arrange the tube within the connecting element, e.g. by adherence, by welding, by non-slip forming of the interface between the tube and the connecting element, etc.

According to a further designed example, it is proposed to arrange a connecting portion at the acoustic exit of the hearing device for directly connecting the acoustic exit with the tube, e.g. by forming a connecting socket, a collar, etc.

The bending of the acoustic exit of the hearing device in the direction of the entrance of the auditory canal can be either achieved by the arcuated forming of the connecting element, so that usually commercially available flexible connecting tubes may be used. But it is also possible that the connecting element is more or less straight lined and that at least a partially preformed acoustic tube is used.

Further, preferred embodiments of the hearing device, according to the present invention, or the proposed connecting and transmission portion, respectively, are characterised within the dependent claims. The invention shall be further explained by examples with reference to the attached figures in which:

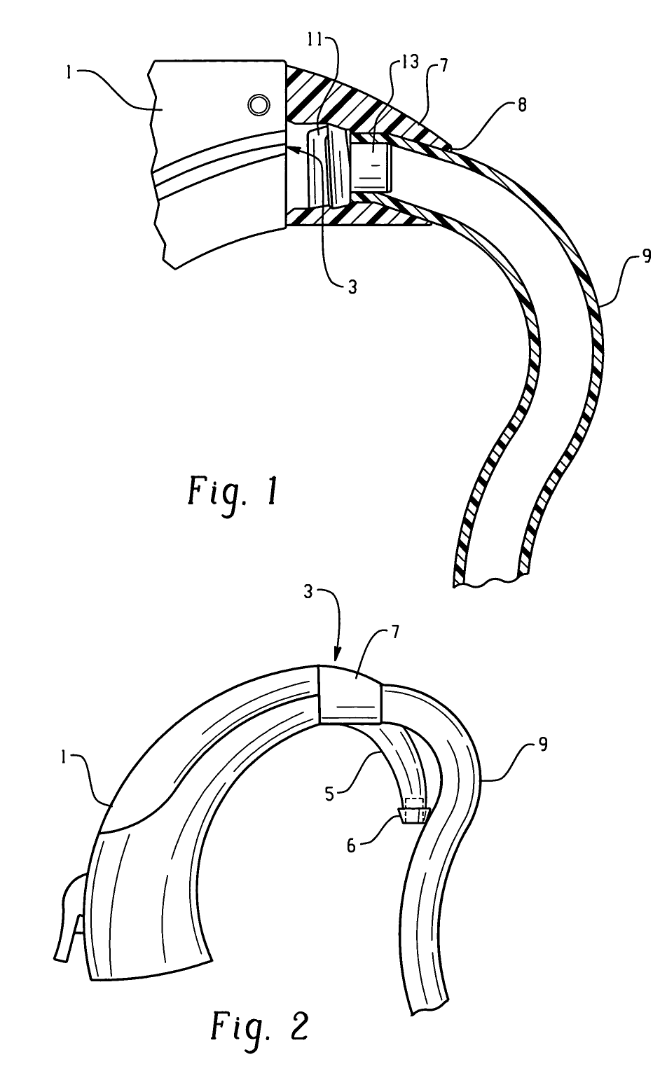

FIG. 1 shows schematically in sectional view a hearing device comprising a today usually used hearing angle as well as the connecting and transmission elements according to the present invention,

FIG. 2 shows in sectional view in enlargement the connection of the sound tube, according to the present invention, directly at the acoustic exit of a hearing device and

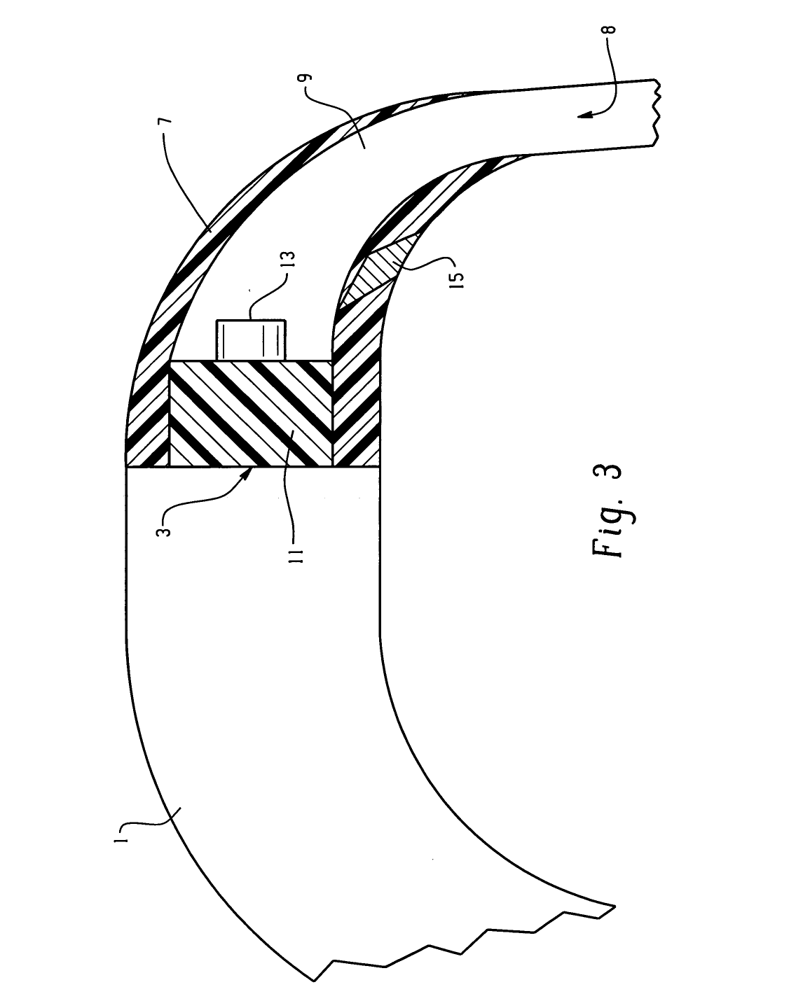

FIG. 3 in sectional view a further example of the arrangement of a sound tube at the acoustic exit of a hearing device.

In FIG. 1 a sectional view of a hearing device 1 is schematically shown comprising at its upper end an acoustic exit 3 at which a today usually used so-called hook 5 is arranged. At the end portion 6 of this hearing angle a tube is usually attached today for the transmission of an acoustic or sound signal, respectively, at or into the auditory canal of an ear.

According to the present invention, it is proposed, instead of the mentioned hearing angle, to arrange a shortened connecting element 7 at the acoustic exit of the hearing device 1 into which connecting element 7 the sound tube 9 is inserted.

Within the enlarged sectional view in FIG. 2, it is shown that preferably tube 9 is directly led onto a shoulder or connecting nipple 13 which is protrusively formed at the acoustic exit 3 of the hearing device 1. The tube 9 is inserted into the connecting element 7, whereby the provided acoustic canal 8 within the connecting element 7 has an interior diameter which corresponds more or less to the outside diameter of the tube 9. By means of a relative stiff connecting element 7, the tube 9 is firmly held at the acoustic exit 3 of the hearing device 1, as the connecting element 7 is turned on and held on a winding 11 at the acoustic exit. Preferably, the tube 9 is firmly connected with the connecting element 7, e.g. by adhering or welding, so that breaking away of the tube is impossible.

Within the embodiment, according to FIG. 2, in which the connecting element has only a relative small bending angle of approximately 10 to 20°, also a pre-arcuated tube 9 can be used which is preferably optimally formed according to the anatomy of the ear. It is well-known that no ear is like another one and therefore the tube to be used is preferably chosen out of a series of “scaled” pre-arcuated tubes. Usually, the connecting element 7 and tube 9 are a unit, so that the selection of different angle/tube combinations is possible.

If a, usually on the market, offered tube should be used, there is also the possibility of producing the bending at the hearing device by using a correspondingly stronger arcuated connecting element as schematically shown in sectional view in FIG. 3. In opposition to the connecting element in FIG. 2, the one shown in FIG. 3 is arcuated in an essentially stronger way and has an angle of approximately 60 to 70°. As a consequence, a today usually offered straight tube 9 can be inserted through the acoustic conduit 8 of the connecting element 7 and again be firmly connected with the connecting element. To assure that the bending of the tube 9 remains during the introduction, preferably wedge-shaped fixing portions 15 are provided within the connecting element 7. Finally, the acoustic transmission tube 9 again is slid onto a connecting portion or connecting nipple 13 at the acoustic exit opening 3, so that an almost stepless transfer portion within the sound or acoustic transmission canal can be achieved.

The great advantage of the present invention is, on the one side, that by respective forming of the connecting element 7 and the sound transmission tube 9 an optimal adaptation to the anatomy of the ear can be achieved which manifests itself in particular in the reduction of noticeability when wearing a hearing device. Moreover, an almost stepless transmission of the sound can be achieved and in addition the bending is to a large extent even, so that an occurrence of impedance jumps or jumps within the sound transmission can be avoided or at least reduced. In addition, an acoustician can change the sound tube separately and in each case the angle is being preserved.

Of course, the described acoustic or sound transmission elements, according to the present invention, are only examples and the design of the connecting element as well as the sound or acoustic transmission tubes 9 can be formed in different ways. Only the fact that the connecting element has a bending of at least less than 80° is an essential distinctive feature compared with the today usually used hooks or bending angles, respectively.

1. Hearing device in particular suitable for being worn at the pinna or behind the ear, respectively, comprising an exit (3) for acoustic or sound signals, characterised in that at the exit (3) a tube-like connecting element (7) is arranged for connecting the exit (3) with a tube (9) for the sound or acoustic transmission in or to an ear canal, the connecting element has a bending angle of less than 80°.

2. Hearing device according to claim 1, characterised in that the tube (9) is introduced into the connecting element (7), which means that the interior diameter of the acoustic canal (8) of the connecting element (7) corresponds approximately to the outer diameter of the tube.

3. Hearing device according to one of the claims 1 or 2, characterised in that the tube (9) is introduced into the connecting element and is firmly connected as e.g. by adhering, by welding, by non-slip forming of the interface between the tube and the connecting element, etc.

4. Hearing device according to one of the claims 1 or 3, characterised in that at the acoustic exit (3) of the hearing device (1) a connecting portion, such as a connecting shoulder or nipple (13), is arranged for connecting the exit (3) with the tube (9).

5. Hearing device according to one of the claims 1 to 4, characterised in that the connecting tube (9) is at least partially pre-arcuated, preferably widely, according to typically occurring contours or correspondingly to the anatomy of an ear.

6. Hearing device according to one of the claims 1 to 5, characterised in that the connecting element (7) is relatively short and has a bending angle in the range of approximately 5 to 45°.

7. Hearing device according to one of the claims 1 to 6, characterised in that the acoustic connecting tube (9) is arranged within the connecting element (7) and firmly attached to the connecting element and is by means of the connecting element (7) held screwably onto a connecting shoulder or connecting nipple (13) at the acoustic exit (3) of the hearing device (1).

8. Hearing device according to one of the claims 1 to 7, characterised in that at the acoustic exit (3) of the hearing device (1) a thread (11) is arranged for the screwable firm arrangement of the connecting element (7).
